(19) United States
(12) Patent Application Publication
(10) Pub. No.: US 2024/0047730 A1
(43) Pub. Date: Feb. 8, 2024

(54) METHOD FOR MANUFACTURING BATTERY PACK

(71) Applicants: PRIMEARTH EV ENERGY CO., LTD., Kosai-shi (JP); TOYOTA JIDOSHA KABUSHIKI KAISHA, Toyota-shi (JP); PRIME PLANET ENERGY & SOLUTIONS, INC., Tokyo (JP)

(72) Inventor: Takaaki IZUMOTO, Toyohashi-shi (JP)

(73) Assignees: PRIMEARTH EV ENERGY CO., LTD., Kosai-shi (JP); TOYOTA JIDOSHA KABUSHIKI KAISHA, Toyota-shi (JP); PRIME PLANET ENERGY & SOLUTIONS, INC., Tokyo (JP)

(21) Appl. No.: 18/228,519

(22) Filed: Jul. 31, 2023

(30) Foreign Application Priority Data
Aug. 3, 2022 (JP) 2022-123731

(51) Int. Cl. H01M 10/04; H01M 10/44; H01M 4/04

(52) U.S. Cl. CPC H01M 10/049; H01M 10/446; H01M 4/0404

(57) ABSTRACT

A method for manufacturing a battery pack includes forming a positive electrode plate; forming a negative electrode plate; forming an electrode body; forming a battery cell; applying a binding load to battery cells; and initially charging the battery cells. When “A mg/cm²” represents a mass of a positive electrode active material on the positive electrode substrate, “C cm³/cm²” represents a volume of pores in the positive electrode substrate, “B mg/cm²” represents a mass of a negative electrode active material on the negative electrode substrate, “D cm³/cm²” represents a volume of pores in the negative electrode substrate, “E cm³/cm²” represents a volume of pores in the separator, and “F N/mm²” represents pressure applied to an opposing portion of a case of the electrode body facing a flat surface of the electrode body, a value of (A+B)/{(C+D+E)/F} is between 1300 and 3000, inclusive.

### BACKGROUND

### 1. Field

The following description relates to a method for manufacturing a battery pack in which battery cells are arranged next to one another.

2. Description of Related Art

Battery packs of lithium-ion rechargeable batteries, which are examples of rechargeable batteries, are often used as high-output power sources for driving vehicles or the like. A battery pack includes battery cells and spacers arranged between adjacent ones of the battery cells. Each battery cell includes a case accommodating an electrode body. Binding bands are used to bind the battery cells and the spacers of the battery pack together. The binding bands apply a fixed binding load to the battery cells and the spacers in the direction in which the battery cells are arranged next to one another. (refer to Japanese Laid-Open Patent Publication No. 2017-84550).

### SUMMARY

When the battery cells are being charged, gas is generated from positive and negative mixture layers included in the electrode body. The gas generated from the mixture layers remaining in the pores of the mixture layers and the pores of the separators increases the internal resistance of the electrode body. From the aspect of releasing the gas, which is generated from the electrode body of the battery cell during charging of the battery cell, out of the electrode body, it is preferred that the binding bands apply a large binding load so that an increased amount of pressure acts on the electrode body accommodated in the case. However, when the binding load applied by the binding bands becomes too large, the case and the electrode body may plastically deform and increase the spring constant of the battery cell. In a state in which the spring constant of the battery cell is high, if the battery cell undergoes contraction due to temperature changes or charging/discharging, the binding load will be greatly decreased. As a result, the accommodation state of the battery cell in each case and the accommodation state of the battery pack may become unstable.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a method for manufacturing a battery pack includes forming a positive electrode plate by applying a positive electrode mixture layer to two surfaces of a positive electrode substrate facing opposite directions; forming a negative electrode plate by applying a negative electrode mixture layer to two surfaces of a negative electrode substrate facing opposite directions; forming a flat electrode body including two flat surfaces by stacking the positive electrode plate and the negative electrode plate with a separator arranged in between; forming a battery cell by accommodating the electrode body in a case with two opposing case side walls of the case respectively facing the two flat surfaces of the electrode body, the battery cell being one of battery cells; applying a binding load to the battery cells such that the case side walls of the battery cells approach one another; and initially charging the battery cells. In the positive electrode plate forming one layer of the electrode body prior to the application of the binding load to the battery cells, “A mg/cm²” represents a sum of a mass of a positive electrode active material included in the positive electrode mixture layer per unit area on a first one of the two surfaces of the positive electrode substrate and a mass of a positive electrode active material included in the positive electrode mixture layer per unit area on a second one of the two surfaces of the positive electrode substrate. Further, “C cm³/cm²” represents a sum of a volume of pores included in the positive electrode mixture layer per unit area on the first surface of the positive electrode substrate and a volume of pores included in the positive electrode mixture layer per unit area on the second surface of the positive electrode substrate. In the negative electrode plate forming one layer of the electrode body prior to the application of the binding load to the battery cells, “B mg/cm²” represents a sum of a mass of a negative electrode active material included in the negative electrode mixture layer per unit area on a first one of the two surfaces of the negative electrode substrate and a mass of a negative electrode active material included in the negative electrode mixture layer per unit area on a second one of the two surfaces of the negative electrode substrate. Further, “D cm³/cm²” represents a sum of a volume of pores included in the negative electrode mixture layer per unit area on the first surface of the negative electrode substrate and a volume of pores included in the negative electrode mixture layer per unit area on the second surface of the negative electrode substrate. In the separator forming one layer of the electrode body prior to the application of the binding load to the battery cells, “E cm³/cm²” represents a volume of pores included in the separator per unit area. In the applying a binding load, “F N/mm²” represents pressure applied per unit area on an opposing portion of one of the two case side walls that faces a corresponding one of the two flat surfaces. A value of (A+B)/{(C+D+E)/F} is between 1300 and 3000, inclusive.

In the above method, the value of (A+B)/{(C+D+E)/F} may be between 1500 and 2500, inclusive.

In the above method, a value of B may be between 37% and 43%, inclusive, of a value of (A+B).

In the above method, a value of F may be between 0.4 N/mm² and 0.9 N/mm², inclusive.

Other features and aspects will be apparent from the following detailed description, the drawings, and the claims.

### BRIEF DESCRIPTION OF THE DRAWINGS

FIG. 1 is a perspective view of a battery pack.

FIG. 2 is a perspective view of a battery cell included in the battery pack.

FIG. 3 is a perspective view of an electrode body in an unrolled state.

FIG. 4 is a schematic view showing a cross-sectional structure of the electrode body in the unrolled state.

FIG. 5 is a side view showing the battery cell and a spacer.

FIG. 6 is a front view of the spacer.

FIG. 7 is a flowchart illustrating a method for manufacturing the battery pack.

FIG. 8 is a front view of the electrode body as viewed from a viewpoint facing a flat surface of the electrode body.

FIG. 9 is a table showing parameters of Examples 1 to 6 and parameters of Comparative Examples 1 to 4.

FIG. 10 is a graph showing the relationship of a reaction resistance and a spring constant of the battery cell, after an initial charging step, relative to a value of parameter G.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

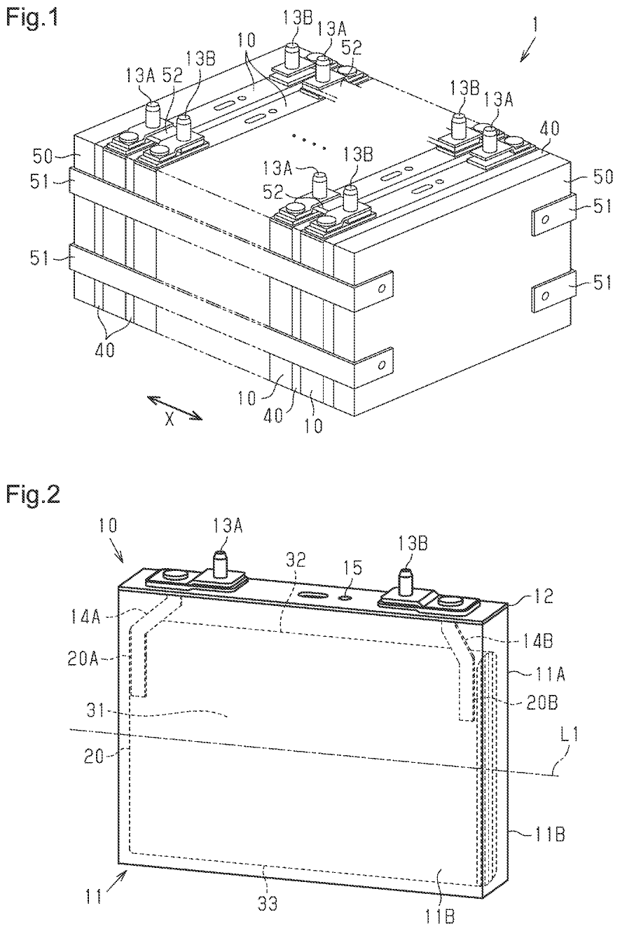

An embodiment of a battery pack will now be described with reference to FIGS. 1 to 10.

### Structure of Battery Pack

As shown in FIG. 1, a battery pack 1 includes battery cells 10, spacers 40, two end plates 50, and binding bands 51. The battery cells 10 are arranged next to one another in an arrangement direction X that is a predetermined single direction. The two end plates 50 are arranged at the two ends of the battery pack 1 in the arrangement direction X. Each binding band 51 is attached to the two end plates 50 so as to connect the two end plates 50. The spacers 40 are arranged in the arrangement direction X between adjacent battery cells 10 and between each end plate 50 and the corresponding adjacent battery cell 10.

The two end plates 50 sandwich the battery cells 10 and the spacers 40 in the arrangement direction X. Each end of the binding band 51 is fastened to the corresponding end plate 50 by a screw. The binding bands 51 are attached to the two end plates 50 so as to apply a predetermined binding load in the arrangement direction X. The end plates 50 and the binding bands 51 apply a binding load to the battery cells 10 and the spacers 40 in the arrangement direction X to hold the battery pack 1 together. In the present embodiment, the two end plates 50 and the binding bands 51 define a binding mechanism.

### Structure of Battery Cell

As shown in FIG. 2, the battery cell 10 is, for example, a non-aqueous rechargeable battery. In an example, the battery cell 10 is a lithium-ion rechargeable battery. Each battery cell 10 includes a case 11. The case 11 includes an accommodation portion 11A and a lid 12. The accommodation portion 11A accommodates an electrode body 20 and a non-aqueous electrolyte. The accommodation portion 11A is box-shaped and has an open upper end.

The lid 12 closes the opening of the accommodation portion 11A. The case 11 forms a sealed battery container by attaching the lid 12 to the accommodation portion 11A. The accommodation portion 11A includes two case side walls 11B opposing each other in the arrangement direction X. One of the case side walls 11B includes a flat plane pressed by a corresponding spacer 40 when the battery pack 1 is assembled. The accommodation portion 11A and the lid 12 are formed from a metal such as aluminum or an aluminum alloy. The accommodation portion 11A has a thickness (plate thickness) of approximately 1 mm or less, preferably, between 0.3 mm and 0.5 mm, inclusive, for example, 0.4 mm

An external terminal 13A of the positive electrode and an external terminal 13B of the negative electrode are arranged on the lid 12. The external terminals 13A and 13B are used to charge and discharge electric power. A positive electrode collector portion 20A, which is the positive electrode end of the electrode body 20, is electrically connected by a positive electrode collector member 14A to the external terminal 13A of the positive electrode. A negative electrode collector portion 20B, which is the negative electrode end of the electrode body 20, is electrically connected by a negative electrode collector member 14B to the external terminal 13B of the negative electrode. The external terminals 13A and 13B do not have to be shaped as shown in FIG. 2 and may have any shape. A busbar 52 (refer to FIG. 1) electrically connects the positive electrode external terminal 13A of a battery cell 10 to the negative electrode external terminal 13B of an adjacent battery cell 10. This connects the adjacent battery cells 10 in series.

An insulative gasket is arranged between the lid 12 and the collector members 14A and 14B. The gasket electrically insulates the lid 12 from the collector members 14A and 14B and seals the gap between the lid 12 and the collector members 14A and 14B. Further, the lid 12 includes an inlet 15 for injection of the non-aqueous electrolyte.

### Electrode Body

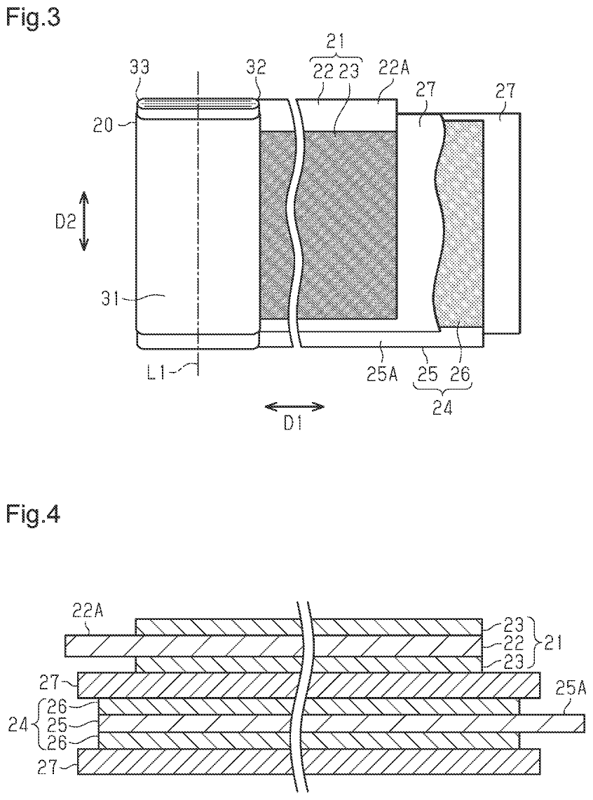

As shown in FIG. 3, the electrode body 20 is a flattened roll formed by rolling a stack of strips of a positive electrode plate 21, a negative electrode plate 24, and separators 27. The positive electrode plate 21, the negative electrode plate 24, and the separators 27 are stacked so that their long sides are parallel to a longitudinal direction D1. Prior to rolling, the positive electrode plate 21, one of the separators 27, the negative electrode plate 24, and the other one of the separators 27 are stacked in this order in a stacking direction (thickness direction). The electrode body 20 is structured by rolling the stack of the positive electrode plate 21 and the negative electrode plate 24 with the separators 27 held in between about a rolling axis L1 that extends in a widthwise direction D2 of the strips. Thus, the positive electrode plate 21 and the negative electrode plate 24 each form layers in the electrode body 20. In the same manner, each separator 27 forms layers in the electrode body 20.

### Positive Plate

As shown in FIG. 4, the positive electrode plate 21 includes a positive electrode substrate 22 and a positive electrode mixture layer 23. The positive electrode substrate 22 is a strip of a foil. The positive electrode mixture layer 23 is applied to each of the two surfaces of the positive electrode substrate 22 facing opposite directions. One end of the positive electrode substrate 22 in the widthwise direction D2 includes a positive electrode uncoated portion 22A where the positive electrode mixture layer 23 is not formed and the positive electrode substrate 22 is exposed.

The positive electrode substrate 22 is a foil of a metal such as aluminum or an alloy having aluminum as a main component. In the roll, the opposing parts in the positive electrode uncoated portion 22A of the positive electrode substrate 22 are pressed together to form the positive electrode collector portion 20A.

The positive electrode mixture layer 23 is formed by hardening a positive electrode mixture paste, which is in a liquid form. The positive electrode mixture paste includes a positive electrode active material, a positive electrode solvent, a positive electrode conductive material, and a positive electrode binder. The positive electrode mixture paste is dried and the positive electrode solvent is vaporized to form the positive electrode mixture layer 23. Accordingly, the positive electrode mixture layer 23 includes the positive electrode active material, the positive electrode conductive material, and the positive electrode binder.

The positive electrode active material is a lithium-containing composite metal oxide that allows for the storage and release of lithium ions, which serve as the charge carrier of the battery cell 10. A lithium-containing composite metal oxide is an oxide containing lithium and a metal element other than lithium. The metal element other than lithium is, for example, one selected from a group consisting of nickel, cobalt, manganese, vanadium, magnesium, molybdenum, niobium, titanium, tungsten, aluminum, and iron contained as iron phosphate in the lithium-containing composite metal oxide.

The lithium-containing composite metal oxide is, for example, lithium cobalt oxide (LiCoO₂), lithium nickel oxide (LiNiO₂), or lithium manganese oxide (LiMn₂O₄). The lithium-containing composite metal oxide is, for example, a three-element lithium-containing composite metal oxide that contains nickel, cobalt, and manganese. The three-element lithium-containing composite metal oxide is, for example, lithium nickel manganese cobalt oxide (LiNiCoMnO₂). The lithium-containing composite metal oxide is, for example, lithium iron phosphate (LiFePO₄).

The positive electrode solvent is an N-methyl-2-pyrrolidone (NMP) solvent, which is one example of an organic solvent. The positive electrode conductive material is, for example, carbon black such as acetylene black or ketjen black, carbon fiber such as carbon nanotubes or carbon nanofiber, or graphite. The positive electrode binder is an example of a resin component included in the positive electrode mixture paste. The positive electrode binder is, for example, polyvinylidene fluoride (PVDF), polyvinyl alcohol (PVA), styrene-butadiene rubber (SBR), or the like.

The positive electrode plate 21 may include an insulation layer at the boundary of the positive electrode uncoated portion 22A and the positive electrode mixture layer 23. The insulation layer includes an insulative inorganic component and a resin component that functions as a binder. The inorganic material is at least one selected from a group consisting of boehmite powder, titania, and alumina. The resin component is at least one selected from a group consisting of PVDF, PVA, and acrylic.

### Negative Electrode Plate

The negative electrode plate 24 includes a negative electrode substrate 25 and a negative electrode mixture layer 26. The negative electrode substrate 25 is a strip of a foil. The negative electrode mixture layer 26 is applied to each of the two surfaces of the negative electrode substrate 25 facing opposite directions. One end of the negative electrode substrate 25 in the widthwise direction D2 at the side opposite the positive electrode uncoated portion 22A includes a negative electrode uncoated portion 25A where the negative electrode mixture layer 26 is not formed and the negative electrode substrate 25 is exposed.

The negative electrode substrate 25 is a foil of a metal such as copper or an alloy having copper as a main component. In the roll, the opposing parts in the negative electrode uncoated portion 25A are pressed together to form the negative electrode collector portion 20B.

The negative electrode mixture layer 26 is formed by hardening a negative electrode mixture paste, which is in a liquid form. The negative electrode mixture paste includes a negative electrode active material, a negative electrode solvent, a negative electrode dispersant, and a negative electrode binder. The negative electrode mixture paste is dried and the negative electrode solvent is vaporized to form the negative electrode mixture layer 26. Accordingly, the negative electrode mixture layer 26 includes the negative electrode active material, the negative electrode dispersant, and the negative electrode binder. The negative electrode mixture layer 26 may further include an additive such as a conductive material.

The negative electrode active material allows for the storage and release of lithium ions. The negative electrode active material is, for example, a carbon material such as graphite, hard carbon, soft carbon, or carbon nanotubes. An example of the negative electrode solvent is water. An example of the negative electrode dispersant may be carboxymethyl cellulose (CMC). The negative electrode binder may use the same material as the positive electrode binder. An example of the negative electrode binder is styrene-butadiene rubber (SBR).

### Separator

The separators 27 prevent contact between the positive electrode plate 21 and the negative electrode plate 24 in addition to holding the non-aqueous electrolyte between the positive electrode plate 21 and the negative electrode plate 24. Immersion of the electrode body 20 in the non-aqueous electrolyte results in the non-aqueous electrolyte permeating each separator 27 from the ends toward the center.

Each separator 27 is a nonwoven fabric of polypropylene or the like. The separator 27 may be, for example, a porous polymer film, such as a porous polyethylene film, a porous polyolefin film, or a porous polyvinyl chloride film, an ion conductive polymer electrolyte film, or the like.

### Non-Aqueous Electrolyte

The non-aqueous electrolyte is a composition containing a supporting electrolyte in a non-aqueous solvent. The non-aqueous solvent is one or two or more selected from, for example, a group consisting of propylene carbonate, ethylene carbonate, diethyl carbonate, dimethyl carbonate, and ethyl methyl carbonate. The supporting electrolyte is a lithium compound (lithium salt) of one or two or more selected from, for example, a group consisting of LiPF₆, LiBF₄, LiClO₄, LiAsF₆, LiCF₃SO₃, LiC₄F₉SO₃, LiN(CF₃SO₂)₂, LiC(CF₃SO₂)₃, LiI, and the like.

In the present embodiment, ethylene carbonate is used as the non-aqueous solvent. Lithium bis(oxalate)borate (LiBOB), which is a lithium salt, is added to the non-aqueous electrolyte as an additive. For example, LiBOB is added to the non-aqueous electrolyte so that the concentration of LiBOB in the non-aqueous electrolyte is between 0.001 mol/L and 0.1 mol/L, inclusive.

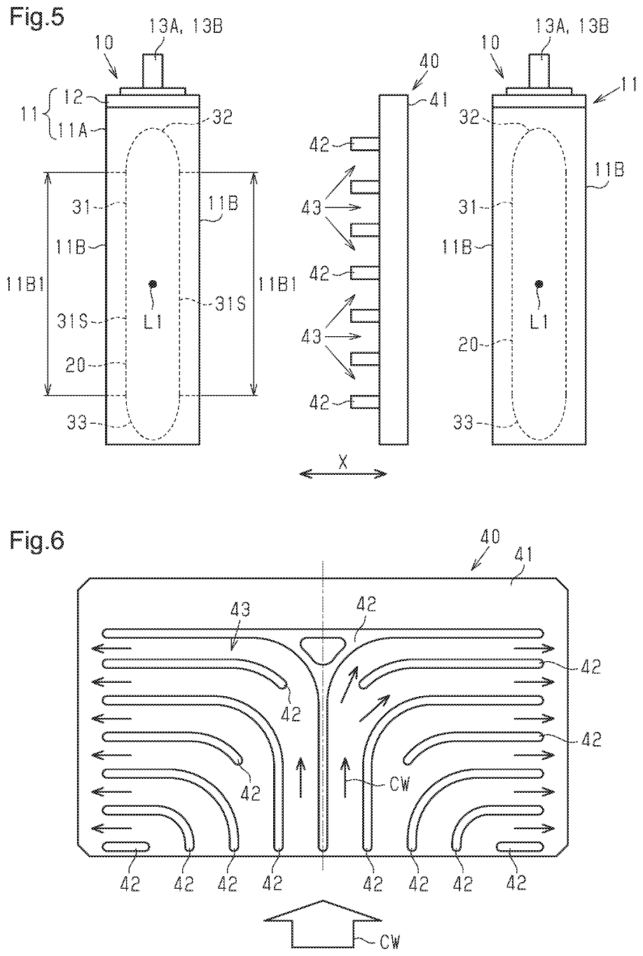

As shown in FIG. 5, the electrode body 20 is arranged so that the rolling axis L1 extends parallel to the bottom surface of the accommodation portion 11A and so that two curved parts of the roll are arranged one above the other. In a state in which the electrode body 20 is accommodated in the case 11, the rolling axis L1 is located at substantially the center of the electrode body 20 in the vertical direction.

The electrode body 20 includes a flat portion 31, an upper curved portion 32, and a lower curved portion 33. The flat portion 31 includes two flat surfaces 31S facing opposite directions. The upper curved portion 32 is located above the flat portion 31. The upper curved portion 32 includes a curved surface that connects upper edges of the two flat surfaces 31S such that the upper curved portion 32 is bulged upwardly from the upper end of the flat portion 31. The lower curved portion 33 is located below the flat portion 31. The lower curved portion 33 includes a curved surface that connects lower edges of the two flat surfaces 31S such that the lower curved portion 33 is bulged downwardly from the lower end of the flat portion 31.

The electrode body 20 is accommodated in the case 11 so that the lower curved portion 33 is located toward the bottom surface of the accommodation portion 11A and the upper curved portion 32 is located toward the lid 12. Each case side wall 11B includes an opposing portion 11B1. The opposing portion 11B1 is where the case side wall 11B faces the flat surface 31S. When the battery pack 1 is assembled, a binding load is applied to the battery cells 10 such that the case side walls 11B of the cases 11 of the battery cells 10 approach one another.

### Spacer

As shown in FIG. 5, each spacer 40 includes a base plate 41 and projections 42. The base plate 41 is, for example, a rectangular plate. The projections 42 are, for example, ribs arranged in a comb-tooth pattern on one surface of the base plate 41. Each projection 42 includes an end surface that is flat to allow for planar contact with the case side wall 11B of the adjacent battery cell 10. The projections 42 are structured to be equal in height from the surface of the base plate 41. Further, the other surface of the base plate 41 is pressed against the case side wall 11B of the other adjacent battery cell 10. In a state in which the binding load is applied, the spacer 40 presses the electrode body 20 via the opposing portion 11B1 of the case side wall 11B.

As shown in FIG. 6, ventilation passages 43 extend between the ribs in a state in which the projections 42 are pressed against the case side wall 11B. The ventilation passages 43 are flow passages through which cooling air CW flows to cool the battery cell 10. The projections 42 are arranged on the spacer 40 such that the cooling air CW enters the ventilation passages 43 from below and flows sideward out of the spacer 40.

### Method for Manufacturing Battery Pack

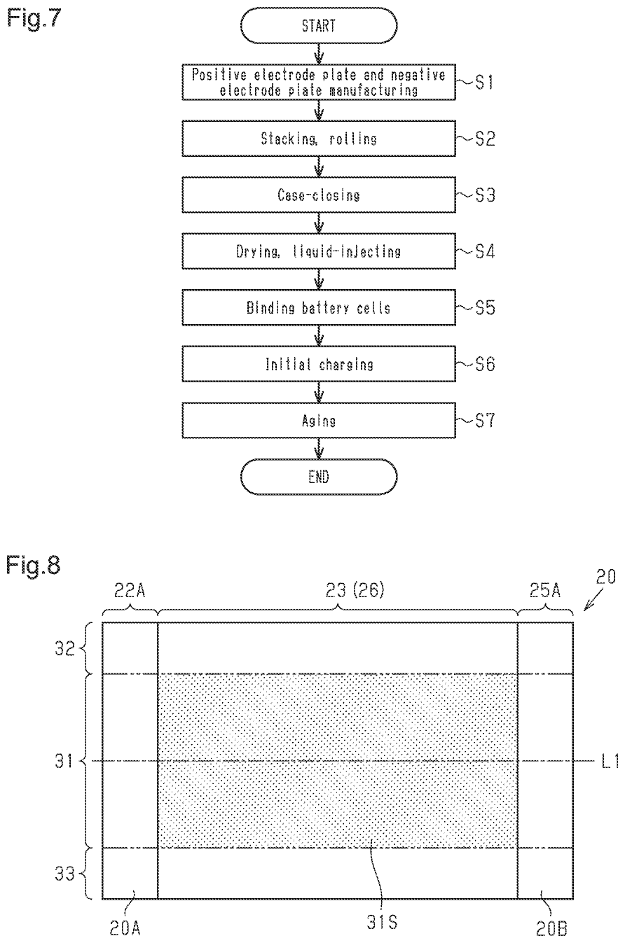

As shown in FIG. 7, a method for manufacturing the battery pack 1 includes steps S1 to S7.

Step S1 is an electrode manufacturing step of manufacturing the positive electrode plate 21 and the negative electrode plate 24. In the step of manufacturing the positive electrode plate 21, the positive electrode mixture paste is applied to the two surfaces of the positive electrode substrate 22 facing opposite directions such that the positive electrode uncoated portion 22A is included at both ends of the positive electrode substrate 22 in the widthwise direction D2. Then, the positive electrode mixture paste is dried to form the positive electrode mixture layer 23. Next, the positive electrode mixture layer 23 formed on the both surfaces of the positive electrode substrate 22 is pressed to adjust the thickness of the positive electrode mixture layer 23. Subsequently, the positive electrode substrate 22 is cut at the center in the widthwise direction D2. In this manner, two strips of the positive electrode plates 21 are manufactured at the same time through the above steps.

In the step of manufacturing the negative electrode plate 24, the negative electrode mixture paste is applied to the two surfaces of the negative electrode substrate 25 facing opposite directions such that the negative electrode uncoated portion 25A is included at both ends of the negative electrode substrate 25 in the widthwise direction D2. Then, negative electrode mixture paste is dried to form the negative electrode mixture layer 26. Next, the negative electrode mixture layer 26 formed on the both surfaces of negative electrode substrate 25 is pressed to adjust the thickness of the negative electrode mixture layer 26. Subsequently, the negative electrode substrate 25 is cut at the center in the widthwise direction D2. In this manner, two strips of the negative electrode plates 24 are manufactured at the same time through the above steps.

Step S2 is a step of manufacturing the electrode body 20 using the positive electrode plate 21, the negative electrode plate 24, and the separators 27. Specifically, the positive electrode plate 21, the negative electrode plate 24, and the separators 27 are stacked and rolled. Further, the roll is pressed and flattened. Then, the positive electrode uncoated portion 22A is pressed to form the positive electrode collector portion 20A, and the negative electrode uncoated portion 25A is pressed to form the negative electrode collector portion 20B. In this manner, the electrode 20 is manufactured in step S2.

Step S3 is a case-closing step in which the electrodes 20 are accommodated in the case 11. The positive electrode collector portion 20A is connected via the positive electrode collector member 14A to the positive electrode external terminal 13A. The negative electrode collector portion 20B is connected via the negative electrode collector member 14B to the negative electrode external terminal 13B. The upper end of the accommodation portion 11A is closed by the lid 12.

Step S4 includes a drying step in which the electrode body 20 is heated to remove moisture from the electrode body 20 and a liquid-injection step of injecting the non-aqueous electrolyte into the case 11. In this manner, the battery cell 10 is assembled.

Step S5 is a binding step of binding the battery cells 10, the spacers 40, and the two end plates 50 using the binding bands 51. The battery cells 10 are arranged such that the case side walls 11B are orthogonal to the arrangement direction X. The spacers 40 are arranged in the arrangement direction X between adjacent battery cells 10 and between each end plate 50 and the corresponding adjacent battery cell 10. The two end plates 50 sandwich the battery cells 10 and the spacers 40 in the arrangement direction X. The binding bands 51 are attached to the end plates 50 so as to apply a predetermined binding load in the arrangement direction X. Then, the busbar 52 electrically connects the positive electrode external terminal 13A of one battery cell 10 to the negative electrode external terminal 13B of the corresponding adjacent battery cell 10. This forms the battery pack 1.

Step S6 is an initial charging step of charging the battery cells 10 included in the battery pack 1. Step S7 is an aging step of aging the battery pack 1, which has undergone the initial charging step, by letting it sit at a high temperature for a certain period of time. The aging step dissolves metal foreign matters in the battery cell 10 and stabilizes a solid electrolyte interphase (SEI) film. After inspections and the like are performed, the manufacturing processes of the battery pack 1 are completed.

### Method for Setting Binding Load

A method for setting the binding load in step S5 will now be described.

When the battery cell 10 is being charged, as in the initial charging step of step S6, gas is generated from the positive electrode active material and the negative electrode active material included in the electrode body 20. The amount of gas generated from the electrode body 20 during charging has a positive correlation with each of a mass of the positive electrode active material and a mass of the negative electrode active material included in the electrode body 20. Thus, as the sum of the mass of the positive electrode active material and the mass of the negative electrode active material increases, a greater amount of gas is generated from the electrode body 20 during charging.

The gas generated from the electrode body 20 remaining in the pores of the positive electrode mixture layer 23, the pores of the negative electrode mixture layer 26, and the pores of the separators 27, increases the internal resistance of the electrode body 20. Accordingly, from the aspect of releasing the gas, which is generated from the electrode body 20 during charging, out of the electrode body 20, it is preferred that the binding load in the step S5 be large so that an increased amount of pressure is applied to the electrode body 20. This decreases the volume of the pores included in the positive electrode mixture layer 23, the negative electrode mixture layer 26, and the separators 27. As a result, the gas remaining in the electrode body 20 is reduced.

However, when the binding load becomes too large, the overly compressed separators 27 will force the non-aqueous electrolyte held by the separators 27 out of the electrode body 20. This will increase the internal resistance of the electrode body 20. Further, when the binding load becomes too large, the case 11 and the electrode body 20 may plastically deform and increase the spring constant of the battery cell 10. In a state in which the spring constant of the battery cell 10 is high, if the battery cell 10 undergoes contraction in the arrangement direction X due to temperature changes or charging/discharging, the binding load will be greatly decreased. As a result, the binding state between the battery cells 10 may become unstable. Accordingly, it is desirable that the binding load be set such that the pressure applied to the electrode body 20 is sufficient to release the gas out of the electrode body 20, and such that the case 11 and the electrode body 20 are not overly compressed.

The binding load in step S5 is set such that the value of G, expressed with the following parameters A to F, is within a predetermined numerical range. The value of G satisfies the following equation of G=(A+B)/{(C+D+E)/F}.

Parameters A to F are described below. In the positive electrode plate 21 forming one layer of the electrode body 20 before the binding (after step S1 and before step S4), the value of A is the sum (mg/cm²) of a mass of the positive electrode active material included in the positive electrode mixture layer 23 per unit area on a first one of the two opposing surfaces of the positive electrode substrate 22 and a mass of the positive electrode active material included in the positive electrode mixture layer 23 per unit area on a second one of the two surfaces of the positive electrode substrate 22. In the negative electrode plate 24 forming one layer of the electrode body 20 before the binding, the value of B is the sum (mg/cm²) of a mass of the negative electrode active material included in the negative electrode mixture layer 26 per unit area on a first one of the two opposing surfaces of the negative electrode substrate 25 and a mass of the negative electrode active material included in the negative electrode mixture layer 26 per unit area on a second one of the two surfaces of the negative electrode substrate 25. The value of (A+B) has a positive correlation with the amount of gas generated from the electrode body 20 during charging. Thus, the value can be used as an index of the amount of gas generated during charging.

The value of A may be calculated in step S1 by using, for example, the weight per unit area (mg/cm²) of the positive electrode mixture layer 23 when preparing the positive electrode plate 21 and a mass ratio of the positive electrode active material included in the positive electrode mixture layer 23. The value of B may be calculated in step S1 by using, for example, the weight per unit area (mg/cm²) of the negative electrode mixture layer 26 when preparing the negative electrode plate 24 and a mass ratio of the negative electrode active material included in the negative electrode mixture layer 26.

The upper limit value of B is, for example, 43%, preferably 41%, of the value of (A+B). The negative electrode active material is more likely to generate gas during charging than the positive electrode active material. Thus, when the value of B is set to the upper limit value or less, increases in the amount of gas generated during charging are limited. Further, from the aspect of ensuring a necessary amount of the negative electrode active material, the lower limit value of B is, for example, 37%, preferably 39%, of the value of (A+B). In an example, the value of B is 40% of the value of (A+B).

During charging of the battery cell 10, gas is generated in the surface of the positive electrode active material and the surface of the negative electrode active material. The surface area of the positive electrode active material has a positive correlation with the mass of the positive electrode active material. The surface area of the negative electrode active material has a positive correlation with the mass of the negative electrode active material. The particle diameter (median diameter D50) of the positive electrode active material in the electrode body 20 is, for example, between 2.8 μm and 6.2 μm, inclusive. The particle diameter (median diameter D50) of the negative electrode active material particles (secondary particles) included in the electrode body 20 is, for example, between 6.6 μm and 11.9 μm, inclusive. A state in which the particle diameter of the positive electrode active material and the particle diameter of the negative electrode active material are in the above ranges is an example of a state in which the sum of the mass of the positive electrode active material and the mass of the negative electrode active material has a positive correlation with the amount of gas generated from the electrode body 20 during charging.

In the positive electrode plate 21 forming one layer of the electrode body 20 before the binding, the value of C is the sum (cm³/cm²) of a volume of the pores included in the positive electrode mixture layer 23 per unit area on the first surface of the positive electrode substrate 22 and a volume of the pores included in the positive electrode mixture layer 23 per unit area on the second surface of the positive electrode substrate 22. In the negative electrode plate 24 forming one layer of the electrode body 20 before the binding, the value of D is the sum (cm³/cm²) of a volume of the pores included in the negative electrode mixture layer 26 per unit area on the first surface of the negative electrode substrate 25 and a volume of the pores included in the negative electrode mixture layer 26 per unit area on the second surface of the negative electrode substrate 25.

The value of C may be calculated before the binding by using the volume and the weight of the positive electrode mixture layer 23 per unit area on each surface of the positive electrode substrate 22 as well as the densities and the weight ratios of each component in the positive electrode mixture layer 23. An example of a method for calculating the value of C is described below for a case where the weight ratios of the positive electrode active material, the positive electrode conductive material, and the positive electrode binder in the positive electrode mixture layer 23 are a:b:c (a+b+c=1). The densities of the positive electrode active material, the positive electrode conductive material, and the positive electrode binder will be referred to as ρₐ, ρ_{b}, and ρ_{c} (mg/cm³), respectively. The sum of the volume of the positive electrode mixture layer 23 per unit area on the first surface of the positive electrode substrate 22 and the volume of the positive electrode mixture layer 23 per unit area on the second surface of the positive electrode substrate 22 will be referred to as V (cm³/cm²). The sum of the weight of the positive electrode mixture layer 23 per unit area on the first surface of the positive electrode substrate 22 and the weight of the positive electrode mixture layer 23 per unit area on the second surface of the positive electrode substrate 22 will be referred to as M (mg/cm²). In this case, C=V−(M×a/ρₐM×b/ρ_{b}+M×c/ρ_{c}) is satisfied. The value of D can also be calculated in the same manner as the value of C.

In the separator 27 forming one layer of the electrode body 20 before the binding, the value of E is a volume (cm³/cm²) of the pores per unit area included in the separator 27. The value of E may be calculated before the binding by using the volume, the weight, and the density of the separator 27 per unit area.

In a state in which the binding load of the step S5 is applied to the battery cell 10, the value of F is the value of pressure (N/mm²) applied to the opposing portion 11B1 of one of the case side walls 11B that faces the flat surface 31S. The area of the opposing portion 11B1 is equal to the area of the flat surface 31S. Thus, the value of F is a value obtained by dividing the binding load by the area of the flat surface 31S.

The flat surface 31S will now be described in detail with reference to FIG. 8. As shown in FIG. 8, the flat surface 31S of the electrode body 20 is part of the flat portion 31 other than the positive electrode collector portion 20A and the negative electrode collector portion 20B. Specifically, each flat surface 31S is formed by either one of the positive electrode mixture layer 23, the negative electrode mixture layer 26, or part of the separator 27 that is in contact with the positive electrode mixture layer 23 or the negative electrode mixture layer 26. When the binding load is applied to the battery cell 10, the case side walls 11B come into contact with the flat surfaces 31S. In FIG. 8, the flat surface 31S is shaded.

The binding load acting on the electrode body 20 reduces the volume of the pores included in the positive electrode mixture layer 23, the negative electrode mixture layer 26, and the separators 27. Thus, the value of {(C+D+E)/F} serves as an index of the volume of the pores decreased by the binding load compared to the volume of the pores included in the positive electrode mixture layer 23, the negative electrode mixture layer 26, and the separator 27 before the binding. That is, the value of {(C+D+E)/F} is an index of the volume of the pores included in the positive electrode mixture layer 23, the negative electrode mixture layer 26, and the separator 27 after the binding.

As described above, the value of G is a ratio of (A+B), which is an index of the amount of gas generated from the electrode body 20, to the value of {(C+D+E)/F}, which is an index of the volume of the pores after the binding. In this manner, the value of G serves as an index for setting the binding load necessary to appropriately release the gas out of the electrode body 20. In other words, the value of G is an index for determining whether an appropriate amount of load is applied to the electrode body 20.

The lower limit of G is 1300, 1483, or 1500. When the value of G is set to the above lower limit values or greater, the gas is appropriately released out of the electrode body 20. The upper limit of G is 3000, 2523, or 2500. When the value of G is set to the above upper limit values or less, excessive pressure will not be applied to the electrode body 20 and the battery cell 10. Thus, when the value of G is within the range from the above lower limit value to the above upper limit value, an appropriate amount of the binding load is applied to the electrode body 20. In other words, when the binding load is set such that the value of G is within the above range, the gas is appropriately released out of the electrode body 20 and excessive pressure will not be applied to the battery cell 10. The range may be set by combining the upper limit values and lower limit values of G described above in any manner.

In an example, the value of F is between 0.4 N/mm² and 0.9 N/mm², inclusive. In another example, the value of F is between 0.41 N/mm² and 0.83 N/mm², inclusive. When the value of F is set within the above ranges, the increase in the spring constant of the battery cell 10 resulting from the binding of the battery cells 10 is limited and the gas generated from the electrode body 20 is appropriately released. In other words, when the value of F is within the above range, the battery cell 10 can be configured such that the value of G is between 1300 and 3000, inclusive, between 1483 and 2523, inclusive, or between 1500 and 2500, inclusive.

### EXAMPLES

The relationship between a reaction resistance of the battery cell 10 and a spring constant of the battery cell 10, after the initial charging step of step S6, relative to the value of G will now be described using Examples 1 to 6 and Comparative Examples 1 to 4. Following examples are to illustrate the advantages of the above embodiment and not to limit the scope of the present disclosure.

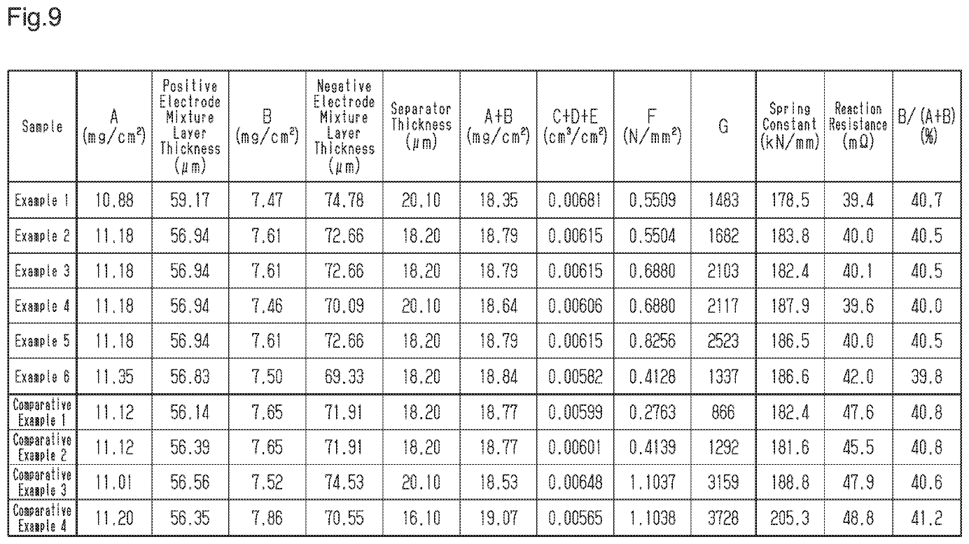

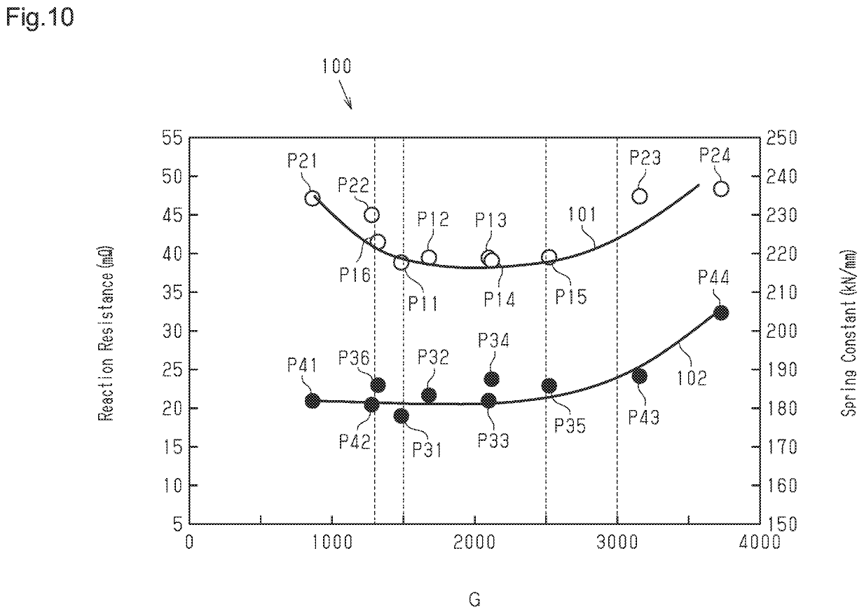

FIG. 9 shows the values of parameters A, B, F, and G, and the values of (A+B), (C+D+E), and B/(A+B) in Examples 1 to 6 and Comparative Examples 1 to 4. Also, the table of FIG. 9 shows the thicknesses of the positive electrode mixture layer 23, the negative electrode mixture layer 26, and the separator 27, which are used to calculate parameters C, D, and E. Further, the table of FIG. 9 and graph 100 of FIG. 10 show the reaction resistance of the battery cell 10 and the spring constant of the battery cell 10 after the initial charging step of step S6 in Examples 1 to 6 and Comparative Examples 1 to 4.

### Example 1

In Example 1, the value of (A+B) was 18.35 mg/cm², and the value of (C+D+E) was 0.00681 cm³/cm². In Example 1, the value of F was set to 0.55 N/mm². The value of G was 1483. The value of B/(A+B) was 40.7%.

### Example 2

In Example 2, the value of (A+B) was 18.79 mg/cm², and the value of (C+D+E) was 0.00615 cm³/cm². In Example 2, the value of F was set to 0.55N/mm². The value of G was 1682. The value of B/(A+B) was 40.5%.

### Example 3

In Example 3, the value of (A+B) was 18.79 mg/cm², and the value of (C+D+E) was 0.00615 cm³/cm². In Example 3, the value of F was set to 0.69 N/mm². The value of G was 2103. The value of B/(A+B) was 40.5%.

### Example 4

In Example 4, the value of (A+B) was 18.64 mg/cm², and the value of (C+D+E) was 0.00606 cm³/cm². In Example 4, the value of F was set to 0.69 N/mm². The value of G was 2117. The value of B/(A+B) was 40.0%.

### Example 5

In Example 5, the value of (A+B) was 18.79 mg/cm², and the value of (C+D+E) was 0.00615 cm³/cm². In Example 5, the value of F was set to 0.83 N/mm². The value of G was 2523. The value of B/(A+B) was 40.5%.

### Example 6

In Example 6, the value of (A+B) was 18.84 mg/cm², and the value of (C+D+E) was 0.00582 cm³/cm². In Example 6, the value of F was set to 0.41 N/mm². The value of G was 1337. The value of B/(A+B) was 39.8%.

### Comparative Example 1

In Comparative Example 1, the value of (A+B) was 18.77 mg/cm², and the value of (C+D+E) was 0.00599 cm³/cm². In Comparative Example 1, the value of F was set to 0.28 N/mm². The value of G was 866. The value of B/(A+B) was 40.8%.

### Comparative Example 2

In Comparative Example 2, the value of (A+B) was 18.77 mg/cm², and the value of (C+D+E) was 0.00601 cm³/cm². In Comparative Example 2, the value of F was set to 0.41 N/mm². The value of G was 1292. The value of B/(A+B) was 40.8%.

### Comparative Example 3

In Comparative Example 3, the value of (A+B) was 18.53 mg/cm², and the value of (C+D+E) was 0.00648 cm³/cm². In Comparative Example 3, the value of F was set to 1.10 N/mm². The value of G was 3159. The value of B/(A+B) was 40.6%.

### Comparative Example 4

In Comparative Example 4, the value of (A+B) was 19.07 mg/cm², and the value of (C+D+E) was 0.00565 cm³/cm². In Comparative Example 4, the value of F was set to 1.10 N/mm². The value of G was 3728. The value of B/(A+B) was 41.2%.

### Evaluations

As shown in FIG. 10, points P11 to P16 plotted on graph 100 represent the reaction resistance (mΩ) of the battery cell 10 after the initial charging step relative to the value of G in Examples 1 to 6. Points P21 to P24 plotted on graph 100 represent the reaction resistance (mΩ) of the battery cell 10 after the initial charging step relative to the value of G in Comparative Examples 1 to 4. Curve 101 in graph 100 is an approximate curve based on points P11 to P16 and points P21 to P24. Curve 101 is an approximate curve representing the changes in the reaction resistance of the battery cell 10 relative to the value of G.

Points P31 to P36 plotted on graph 100 represent the spring constant (kN/mm) of the battery cell 10 after the initial charging step relative to the value of G in Examples 1 to 6. Points P41 to P44 plotted on graph 100 represent the spring constant (kN/mm) of the battery cell 10 after the initial charging step relative to the value of G in Comparative Examples 1 to 4. Curve 102 in graph 100 is an approximate curve based on points P31 to P36 and points P41 to P44. Curve 102 is an approximate curve representing the changes in the spring constant of the battery cell 10 relative to the value of G. The spring constant of the battery cell 10 refers to a spring constant of the entire battery cell 10, including the case 11 and the electrode body 20, when a load is applied to the opposing portion 11B1 of the battery cell 10 in the arrangement direction X.

In Examples 1 to 6 in which the value of G was between 1300 and 3000, the reaction resistance of the battery cell 10 after the initial charging step of the step S6 was between 39.4 mΩ and 42.0 mΩ, inclusive. In particular, in Examples 1 to 5 in which the value of G was between 1483 and 2523, inclusive, the reaction resistance of the battery cell 10 after the initial charging step of step S6 was between 39.4 mΩ and 40.1 mΩ, inclusive.

On the other hand, in Comparative Examples 1 and 2, in which the value of G was less than 1300, the reactive resistance was 47.6 mΩ and 45.5 mΩ, respectively. That is, in Comparative Examples 1 and 2, the reaction resistance was increased as compared with Examples 1 to 6. The reaction resistance was increased in Comparative Examples 1 and 2 because the binding load applied to the electrode body 20 was not enough, thereby causing the gas generated from the electrode body 20 during charging to remain inside the electrode body 20 and increase the internal resistance of the electrode body 20.

Further, in Comparative Examples 3 and 4 in which the value of G was greater than 3000, the reactive resistance was 47.9 mΩ and 48.8 mΩ, respectively. That is, in Comparative Examples 3 and 4, the reaction resistance was increased as compared with Examples 1 to 6. The reaction resistance was increased in Comparative Examples 3 and 4 because the binding load applied to the electrode body 20 was too large, thereby causing the overly compressed electrode body 20 to force the non-aqueous electrolyte out of the separators 27 and increasing the internal resistance of the electrode body 20.

In Examples 1 to 6, the spring constant of the battery cell 10 after the initial charging step in step S6 was between 178.5 kN/mm and 187.9 kN/mm, inclusive. In Comparative Examples 1 and 2, the spring constant of the battery cell 10 was substantially equal to those of Examples 1 to 6. On the other hand, in Comparative Example 3 in which the value of G was greater than 3000, the spring constant of the battery cell 10 was 188.8 kN/mm. That is, in Comparative Example 3, the spring constant of the battery cell 10 was slightly increased. In Comparative Example 4 in which the value of G was maximal, the spring constant of the battery cell 10 was 205.3 kN/mm. That is, in Comparative Example 4, the spring constant of the battery cell 10 was significantly increased as compared with those of Examples 1 to 6. The spring constant of the battery cell 10 was increased in Comparative Examples 3 and 4 because the binding load applied to the electrode body 20 was too large, thereby causing excessive plastic deformation of the case 11 and the electrode body 20.

As described above, when the binding load is set such that the value of G is in the range from 1300 to 3000, inclusive, the increase in the spring constant of the battery cell 10 is limited and the increase in the internal resistance of the electrode body 20 is limited. In particular, when the binding load is set such that the value of G is in the range from 1483 to 2523, inclusive, the increase in the internal resistance of the electrode body 20 is further limited.

### ADVANTAGES OF THE EMBODIMENT

The above embodiment has the following advantages.

(1) When the binding load is set such that the value of G is within the range from 1300 to 3000, inclusive, the gas is appropriately released out of the electrode body 20 and excessive pressure will not be applied to the battery cell 10. This limits the increase in the spring constant of the electrode body 20 and the increase in the internal resistance of the battery cell 10.

(2) When the binding load is set such that the value of G is within the range from 1483 to 2523, inclusive or the range from 1500 to 2500, inclusive, the increase in the internal resistance of the electrode body 20 is further limited.

(3) When the value of B is between 37% and 43%, inclusive or between 39% and 41%, inclusive of the value of (A+B), a necessary amount of the negative electrode active material is ensured and increases in the gas generated during charging are limited.

(4) When the value of F is between 0.4 N/mm² and 0.9 N/mm², inclusive or between 0.41 N/mm² and 0.83 N/mm², inclusive, the increase in the spring constant of the battery cell 10 is limited and the gas generated from the electrode body 20 is appropriately released.

### MODIFIED EXAMPLES

The above embodiment may be modified as described below.

As long as the value of G is in the range from 1300 to 3000, the value of F may be less than 0.4 N/mm 2 or greater than 0.9 N/mm 2.

As long as the value of G is in the range from 1300 to 3000 and the internal resistance of the electrode body 20 is not overly increased, the value of B may be less than 37% or greater than 43% of the value of (A+B).

As long as the spring constant of the battery cell 10 is not overly increased and the internal resistance of the electrode body 20 is not overly increased, the value of G may be greater than or equal to 1300 and less than 1483. Further, the value of G may be greater than 2523 and less than or equal to 3000.

The battery pack 1 does not have include the spacer 40 between adjacent battery cells 10. In this case, when the battery cells 10 are bound to assemble the battery pack 1, the case side wall 11B of a battery cell 10 comes into contact with the case side wall 11B of an adjacent battery cell 10. Even in this case, the binding load mainly acts on the opposing portion 11B1 of the case side wall 11B that faces the electrode body 20 in each battery cell 10.

The electrode body 20 does not have to be a roll and may a stack of the positive electrode plate 21, the negative electrode plate 24, and the separator 27 accommodated in the case 11. In this case, the electrode body 20 will not include the upper curved portion 32 and the lower curved portion 33.

The battery cell 10 may be used in an automatic transporting vehicle, a special hauling vehicle, a battery electric vehicle, a hybrid electric vehicle, a computer, an electronic device, or any other system. For example, the battery cell 10 may be used in a marine vessel, an aircraft, or any other type of movable body. The battery cell 10 may also be used in a system that supplies electric power from a power plant via a substation to buildings and households.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A method for manufacturing a battery pack, the method comprising:
forming a positive electrode plate by applying a positive electrode mixture layer to two surfaces of a positive electrode substrate facing opposite directions;
forming a negative electrode plate by applying a negative electrode mixture layer to two surfaces of a negative electrode substrate facing opposite directions;
forming a flat electrode body including two flat surfaces by stacking the positive electrode plate and the negative electrode plate with a separator arranged in between;
forming a battery cell by accommodating the electrode body in a case with two opposing case side walls of the case respectively facing the two flat surfaces of the electrode body, the battery cell being one of battery cells;
applying a binding load to the battery cells such that the case side walls of the battery cells approach one another; and
initially charging the battery cells,
wherein in the positive electrode plate forming one layer of the electrode body prior to the application of the binding load to the battery cells:
“A mg/cm²” represents a sum of a mass of a positive electrode active material included in the positive electrode mixture layer per unit area on a first one of the two surfaces of the positive electrode substrate and a mass of a positive electrode active material included in the positive electrode mixture layer per unit area on a second one of the two surfaces of the positive electrode substrate; and
“C cm³/cm²” represents a sum of a volume of pores included in the positive electrode mixture layer per unit area on the first surface of the positive electrode substrate and a volume of pores included in the positive electrode mixture layer per unit area on the second surface of the positive electrode substrate,
wherein in the negative electrode plate forming one layer of the electrode body prior to the application of the binding load to the battery cells:
“B mg/cm³” represents a sum of a mass of a negative electrode active material included in the negative electrode mixture layer per unit area on a first one of the two surfaces of the negative electrode substrate and a mass of a negative electrode active material included in the negative electrode mixture layer per unit area on a second one of the two surfaces of the negative electrode substrate; and
“D cm³/cm²” represents a sum of a volume of pores included in the negative electrode mixture layer per unit area on the first surface of the negative electrode substrate and a volume of pores included in the negative electrode mixture layer per unit area on the second surface of the negative electrode substrate;
wherein in the separator forming one layer of the electrode body prior to the application of the binding load to the battery cells, “E cm³/cm²” represents a volume of pores included in the separator per unit area; and
wherein in the applying a binding load, “F N/mm²” represents pressure applied per unit area on an opposing portion of one of the two case side walls that faces a corresponding one of the two flat surfaces, and
wherein a value of (A+B)/{(C+D+E)/F} is between 1300 and 3000, inclusive.

2. The method according to claim 1, wherein the value of (A+B)/{(C+D+E)/F} is between 1500 and 2500, inclusive.

3. The method according to claim 1, wherein a value of B is between 37% and 43%, inclusive, of a value of (A+B).

4. The method according to claim 3, wherein a value of F is between 0.4 N/mm² and 0.9 N/mm², inclusive.
